(19) United States
(12) Patent Application Publication
(10) Pub. No.: US 2013/0183086 A1
(43) Pub. Date: Jul. 18, 2013

(54) TORSIONAL QUICK-CONNECT FASTENING DEVICE

(71) Applicant: Ting-Jui Wang, New Taipei (TW)

(72) Inventor: Ting-Jui Wang, New Taipei (TW)

(73) Assignee: DTECH PRECISION INDUSTRIES CO., LTD., New Taipei (TW)

(21) Appl. No.: 13/352,862

(22) Filed: Jan. 18, 2012

(51) Int. Cl. F16B 5/00

(52) U.S. Cl. 403/327

(57) ABSTRACT

A torsional quick-connect fastening device includes a housing, a rotatable retainer, and a torsional elastic element. The housing can be a hollow cylinder or other shape. The rotatable retainer is movably received in an inner receiving space of the housing, and has an interconnecting rod with a force-application portion and a retaining section connected to two opposite ends thereof. The torsional elastic element is a coiled torsion spring with two ends fixedly connected to the housing and the rotatable retainer, so as to bring the rotatable retainer to rotate while moving axially. When the housing is attached to a first plate and the rotatable retainer is operated to rotate and extend the retaining section through a second plate, the torsional elastic element automatically turns the retaining section to a position for firmly pressing against the second plate, so that the two plates are quickly and conveniently fastened together.

### FIELD OF THE INVENTION

The present invention relates to a quick-connect fastening device, and more particularly to a torsional quick-connect fastening device for quickly fastening or separating two plates to or from each other with the aid of a torsional elastic element.

### BACKGROUND OF THE INVENTION

Conventional fastening elements for connecting two plates usually utilize screw threads to lock the two plates to each other. In an embodiment thereof, the conventional fastening element includes a screw, an annular cap, and a sleeve. The screw has a head serving as a force application end and provided on a top with a slot for receiving a driver tip, and a threaded shank connected to the head opposite to the slotted top. The annular cap is a hollow member fitted around the head for enclosing and protecting the screw. The sleeve is fitted around the threaded shank. To use the above-structured fastening element, first associate the annular cap with a first plate, and then align the threaded shank with a locking hole on a second plate. Then, use a tool to apply a turning force at the slot of the screw head, so that the threaded shank is driven into the locking hole on the second plate to thereby connect the two plates to each other.

While the screw can firmly lock two plates together, it is troublesome and time consuming to use an additional tool to apply a turning force at the force application end, i.e. the screw head to drive the threaded shank into the two plates to be fastened together. Later, there are some other different technical structures being developed for fastening two plates together. However, all these fastening structures do not provide stable function and the two fastened plates tend to undesirably loosen or even separate from each other.

It is therefore tried by the inventor to develop an improved torsional quick-connect fastening device that can be easily and conveniently operated to quickly and firmly connect two plates to each other.

### SUMMARY OF THE INVENTION

A primary object of the present invention is to provide a torsional quick-connect fastening device, with which a first and a second plate can be quickly assembled and fastened to each other in an easy and convenient manner without the need of using an additional tool to tighten screws.

To achieve the above and other objects, the torsional quick-connect fastening device according to a first preferred embodiment of the present invention is designed to quickly fasten a first plate to a second plate simply through a pressing and turning movement, and includes a housing, a rotatable retainer, and a torsional elastic member. The housing is a hollow tubular member attached to the first plate, and has a first open end, an opposite second open end, an internal receiving space communicating with the first and the second open end, and a first holding structure provided on the housing at a predetermined position. The rotatable retainer is a long rod having a force-application portion, an interconnecting rod connected at an outer end to the force-application portion, a retaining section connected to an inner end of the interconnecting rod opposite to the force-application portion, and a second holding structure provided on the rotatable retainer at a predetermined position. The retaining section is a block having at least one pressing surface facing toward the force-application portion. The interconnecting rod is movably received in the receiving space of the housing, such that the force-application portion is located outside the first open end of the housing and the retaining section is located at the second open end of the housing and outward extendable to extend through and be retained to behind the second plate when being turned. The torsional elastic element is a coiled wire torsion spring, and has a first fixing end connected to the first holding structure on the housing and an opposite second fixing end connected to the second holding structure on the rotatable retainer, so as to bring the rotatable retainer to rotate.

In the above first preferred embodiment, the first holding structure is a first holding hole or slot provided on the housing, and the first fixing end of the torsional elastic element is inserted into the first holding hole or slot.

In the above first preferred embodiment, the second holding structure is a second holding hole or slot provided on the rotatable retainer, and the second fixing end of the torsional elastic element is inserted into the second holding hole or slot.

In the above first preferred embodiment, the torsional elastic element is a coiled wire torsion-compression spring or a coiled wire torsion-extension spring.

In the above first preferred embodiment, the force-application portion of the rotatable retainer is a hand-operating plate fixedly connected to the outer end of the interconnecting rod.

In a variant of the first preferred embodiment, the force-application portion of the rotatable retainer is an operating lever. The operating lever includes a hand lever and an acting section extended from the hand lever, and the acting section is pivotally turnably connected to the outer end of the interconnecting rod, such that when a force is applied via the hand lever, the rotatable retainer is brought to move.

In a preferred embodiment, the retaining section of the rotatable retainer is an oblong or a rectangular block and has two laterally symmetrical pressing surfaces facing toward the force-application portion.

In another preferred embodiment, the retaining section of the rotatable retainer is an externally threaded cylinder.

To achieve the above and other objects, the torsional quick-connect fastening device according to a second preferred embodiment of the present invention includes a housing having an inner receiving space communicating with at least two corresponding open ends and a first holding structure provided on the housing at a predetermined position; a rotatable retainer having an interconnecting rod movably received in the receiving space of the housing, a force-application portion connected to an end of the interconnecting rod and located outside one open end of the housing, a retaining section connected to another end of the interconnecting rod to locate at the other open end of the housing and be outward extendable through and retained to behind the second plate when being turned, and a second holding structure provided on the rotatable retainer at a predetermined position; and a torsional elastic element having two ends fixedly connected to the first and the second holding structure.

In the second preferred embodiment, the housing is U-shaped with the receiving space formed therein. And, the U-shaped housing has one open side forming an assembling side for attaching to a mounting side of the first plate.

In the second preferred embodiment, the assembling side is provided with a plurality of locating projections for inserting into the mounting side of the first plate and a locking section for locking to the mounting side of the first plate in a predetermined manner.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view of a torsional quick-connect fastening device according to a first preferred embodiment of the present invention;

FIG. 2 is a cutaway view of the torsional quick-connect fastening device according to the first preferred embodiment of the present invention;

FIG. 3 is an assembled sectional view of the torsional quick-connect fastening device according to the first preferred embodiment of the present invention;

FIG. 4 is a sectional view showing the torsional quick-connect fastening device according to the first preferred embodiment of the present invention in use and the operating manner thereof;

FIG. 5 is a bottom view showing the turning of the torsional quick-connect fastening device according to the first preferred embodiment of the present invention to a locked position;

FIG. 6 is an assembled sectional view of a first variant of the torsional quick-connect fastening device according to the first preferred embodiment of the present invention, in which a coiled wire torsion-extension spring is employed;

FIG. 7 shows the torsional quick-connect fastening device of FIG. 6 in use and the operating manner thereof;

FIG. 8 is an assembled sectional view of a second variant of the torsional quick-connect fastening device according to the first preferred embodiment of the present invention, in which a coiled wire torsion-compression spring is employed;

FIG. 9 shows the torsional quick-connect fastening device of FIG. 8 in use and the operating manner thereof;

FIG. 10 is a cutaway view of a third variant of the torsional quick-connect fastening device according to the first preferred embodiment of the present invention, in which an operating lever and a torsion-compression spring are employed;

FIG. 11 is a sectional view showing the third variant of the torsional quick-connect fastening device according to the first preferred embodiment of the present invention in use and the operating manner thereof;

FIG. 12 is a cutaway view of a fourth variant of the torsional quick-connect fastening device according to the first preferred embodiment of the present invention, in which an operating lever and a coiled wire torsion-extension spring are employed;

FIG. 13 is a sectional view showing the fourth variant of the torsional quick-connect fastening device according to the first preferred embodiment of the present invention in use and the operating manner thereof;

FIG. 14 is a perspective view showing a rotatable retainer for the torsional quick-connect fastening device of the present invention has a retaining section in the form of an externally threaded cylinder;

FIG. 15 is a partially sectioned side view showing a torsional quick-connect fastening device according to a second preferred embodiment of the present invention in use;

FIG. 16 is a partially sectioned top view of FIG. 15;

FIG. 17 is an exploded perspective view of a first variant of the torsional quick-connect fastening device according to the second preferred embodiment of the present invention, in which an operating lever is employed;

FIG. 18 is an exploded front view of FIG. 17;

FIG. 19 is an assembled rear view of FIG. 17;

FIG. 20 is a side view showing the rotatable retainer for the torsional quick-connect fastening device of the present invention is provided with a first stopper;

FIG. 21 is a side view showing the rotatable retainer for the torsional quick-connect fastening device of the present invention is provided with an operating lever and a first stopper;

FIG. 22 is a cross sectional view showing a housing for the torsional quick-connect fastening device of the present invention is internally provided with a second stopper for correspondingly interfering with the first stopper on the rotatable retainer; and

FIG. 23 is a cross sectional view similar to FIG. 22 showing the second stopper defines a maximum range within which the first stopper can be turned.

### DETAILED DESCRIPTION OF THE PREFERRED EMBODIMENTS

The present invention will now be described with some preferred embodiments thereof and with reference to the accompanying drawings. For the purpose of easy to understand, elements that are the same in the preferred embodiments are denoted by the same reference numerals.

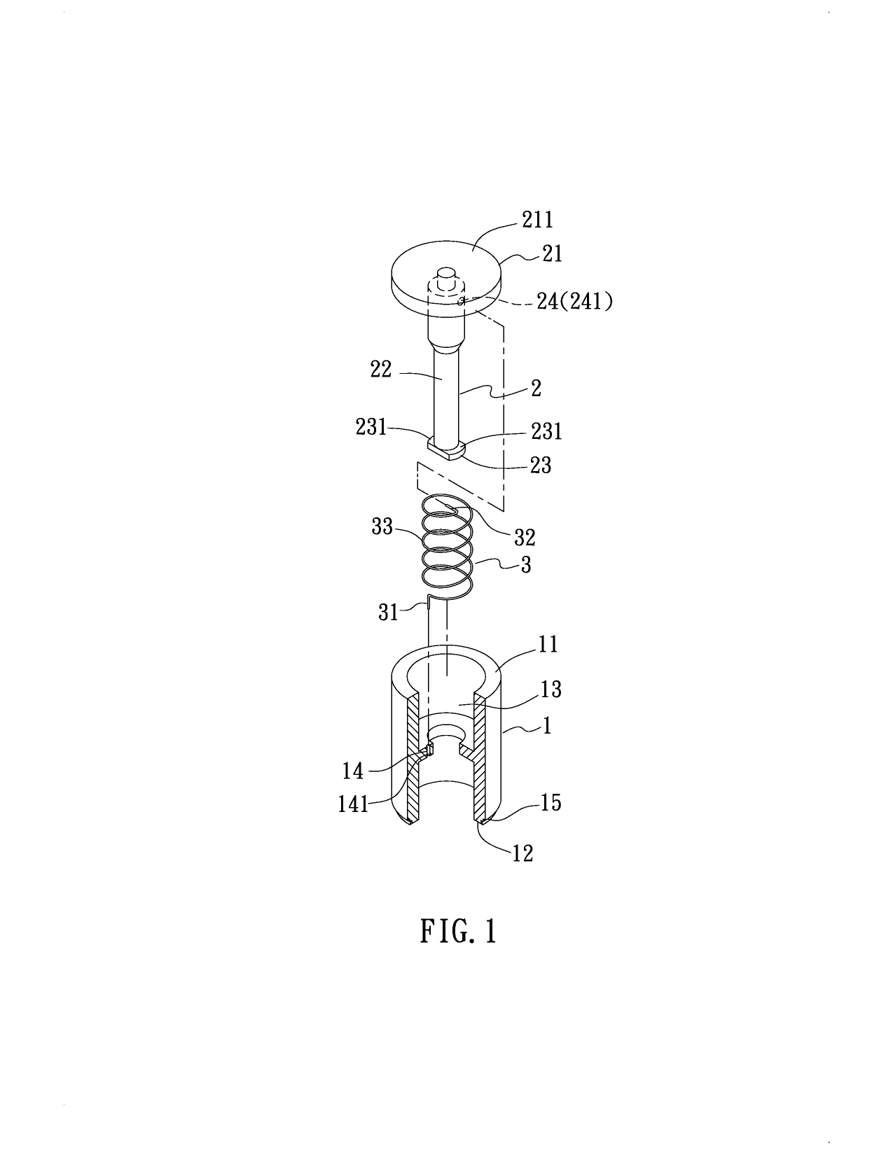

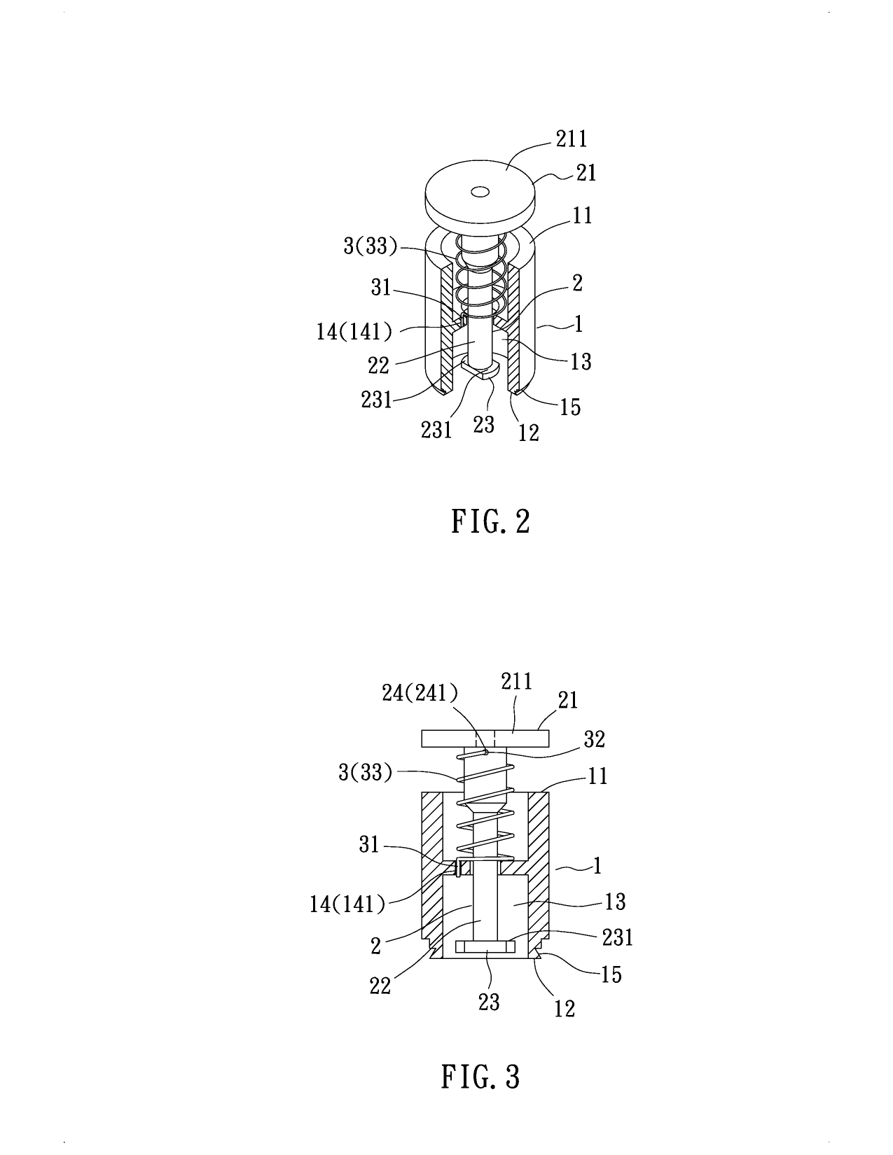

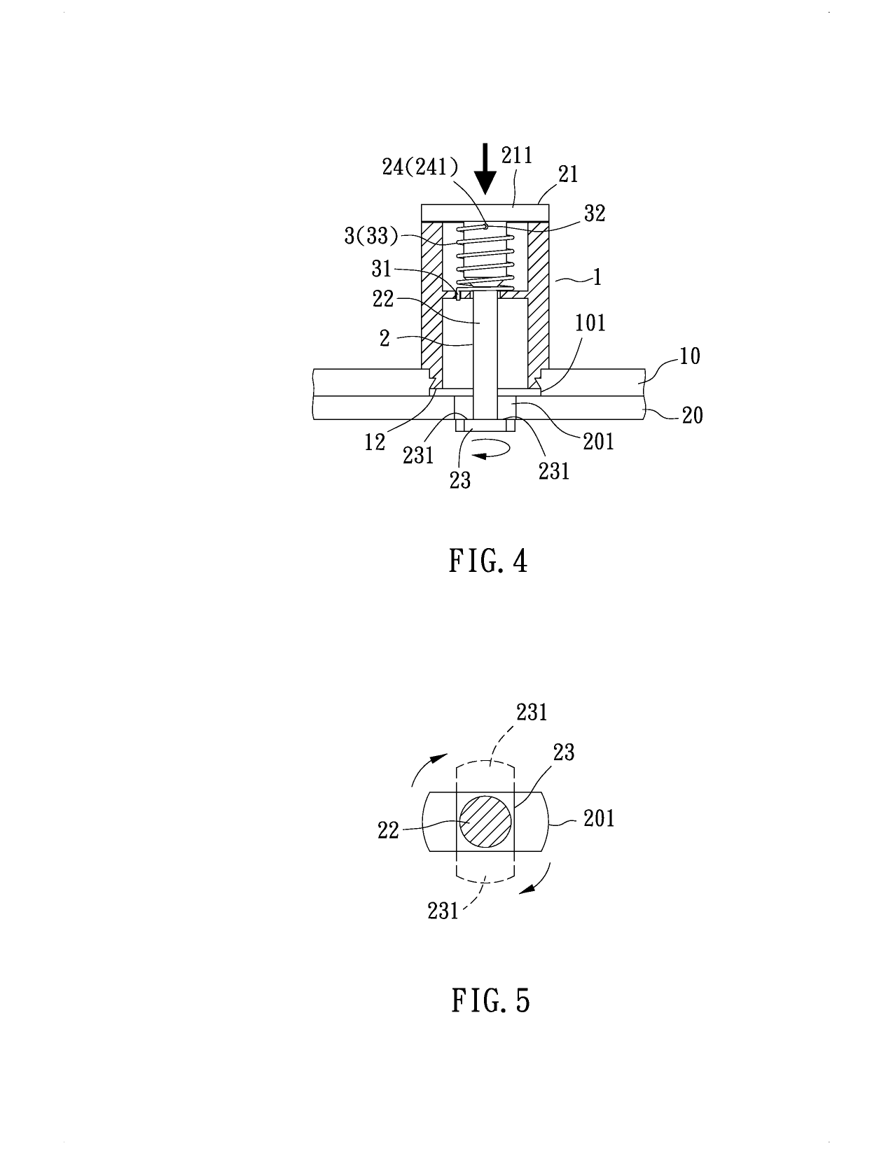

Please refer to FIGS. 1 to 3. A torsional quick-connect fastening device according to a first preferred embodiment of the present invention includes a housing 1, a rotatable retainer 2, and a torsional elastic element 3. As shown in FIG. 4, the torsional quick-connect fastening device of the present invention is designed for attaching to a first plate 10 and quickly fastening the first plate 10 to a second plate 20.

In the first preferred embodiment, the housing 1 is a hollow tubular member for attached to the first plate 10, as shown in FIG. 4, and can be cylindrical or polygonal in cross-sectional shape. The housing 1 has a first open end 11 and an opposite second open end 12; an inner receiving space 13 communicating with the first and the second open end 11, 12; a first holding structure 14 provided on the housing 1 at a predetermined position; and an assembling section 15 formed on an end surface of the first open end 11 or the second open end 12 for inserting into and connected to an attaching hole 101 on the first plate 10 by way of riveting, screwing, hooking, welding, or expansion connection. In the illustrated first preferred embodiment, the assembling section 15 is formed on the end surface of the second open end 12 of the housing 1.

The rotatable retainer 2 is a long rod axially received in the receiving space 13 of the housing 1 and can be rotated to lock to the second plate 20. As can be seen in FIGS. 1 to 3, the rotatable retainer 2 includes a force-application portion 21, an interconnecting rod 22 connected at an outer end to the force-application portion 21, a retaining section 23 connected to an inner end of the interconnecting rod 22 opposite to the force-application portion 21, and a second holding structure 24 provided on the rotatable retainer 2 at a predetermined position. A user may apply a force at the force-application portion 21 to axially move while rotating the rotatable retainer 2. The retaining section 23 illustrated in FIGS. 1 to 3 is a block having at least one pressing surface 231 facing toward the force-application portion 21. The retaining section 23 can be extended through a locking hole 201 pre-formed on the second plate 20 and then turned for the pressing surface 231 to abut on and press against a rear side of the second plate 20. The interconnecting rod 22 of the rotatable retainer 2 is movably received in the receiving space 13 of the housing 1, the force-application portion 21 is located outside an end, i.e. the first open end 11, of the housing 1, and the retaining section 23 is outward extendably located at the other end, i.e. the second open end, of the housing 1. With these arrangements, the retaining section 23 extended through the locking hole 201 can be turned via the force-application portion 21 to abut on and press against the second plate 20.

The torsional elastic element 3 illustrated in FIGS. 1 to 3 is a coiled wire torsion spring having a first fixing end 31 and an opposite second fixing end 32. The first fixing end 31 is connected to the first holding structure 14 on the housing 1, and the second fixing end 32 is connected to the second holding structure 24 on the rotatable retainer 2. With the torsional elastic element 3 arranged in the above manner, the rotatable retainer 2 can be brought by the torsional elastic element 3 to move axially while rotating, so that the retaining section 23 can be automatically turned or moved to an original position by a spring force of the torsional elastic element 3 to fasten the second plate 20 to the first plate 10 or release the second plate 20 from the first plate 10, respectively.

Please refer to FIGS. 4 and 5 for the use and the operating manner of the torsional quick-connect fastening device according to the first preferred embodiment of the present invention. As shown, the second open end of the housing 1 is first attached to the attaching hole 101 on the first plate 10 by way of riveting, welding, screwing, expansion connection or other suitable ways. To fasten the first plate 10 and the second plate 20 together, first apply a pressing and a rotating force at the force-application portion 21 of the rotatable retainer 2 for the interconnecting rod 22 and the retaining section 23 to pass through the locking hole 201 on the second plate 20. Then, an elastic restoring force of the torsional elastic element 3 automatically turns the retaining section 23 behind the locking hole 201, as shown in FIG. 5, so that the at least one pressing surface 231 of the retaining section 23 abuts on and presses against the rear side of the second plate 20 to achieve the function of quickly fastening the first and the second plate 10, 20 to each other. On the other hand, when the rotatable retainer 2 is rotated reversely to release the retaining section 23 from behind the locking hole 201, the elastic restoring force of the torsional elastic element 3 also automatically rotates the rotatable retainer 2 while axially moves the latter to its original position in the housing 1, so that the first plate 10 can be quickly, easily and conveniently separated from the second plate 20.

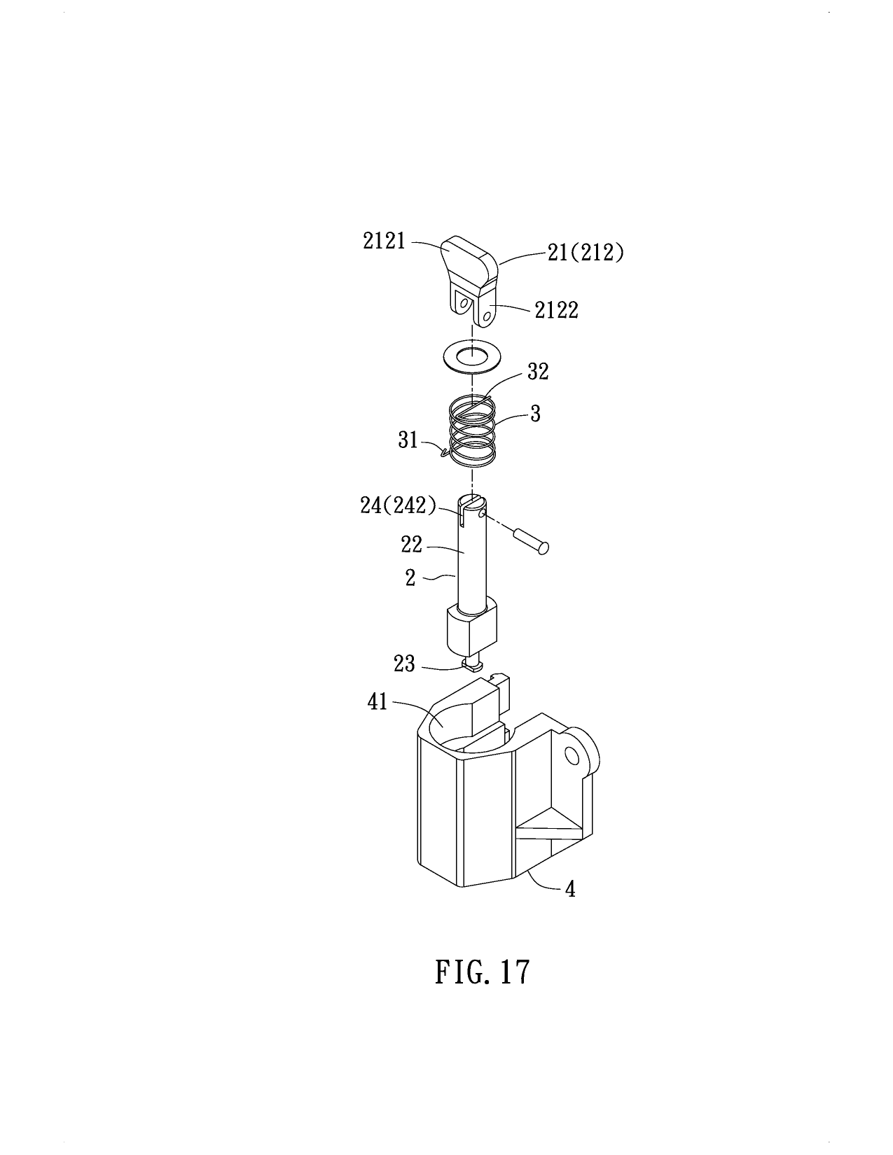

In the first preferred embodiment illustrated in FIGS. 1 to 4, for the torsional elastic element 3 to axially move the rotatable retainer 2 while rotating the latter so that the retaining section 23 is automatically brought to a position for retaining to behind the locking hole 201 on the second plate 20, the first holding structure 14 provided on the housing 1 at a predetermined position is configured as a first holding hole 141 or a first holding slot or other similar structure, and the first fixing end 31 of the torsional elastic element 3 is fixedly inserted into the first holding hole 141; meanwhile, the second holding structure 24 provided on the rotatable retainer 2 at a predetermined position is configured as a second holding hole 241 or a second holding slot 242 (as that shown in FIG. 17) or other similar structure, and the second fixing end 32 of the torsional elastic element 3 is fixedly inserted into the second holding hole 241.

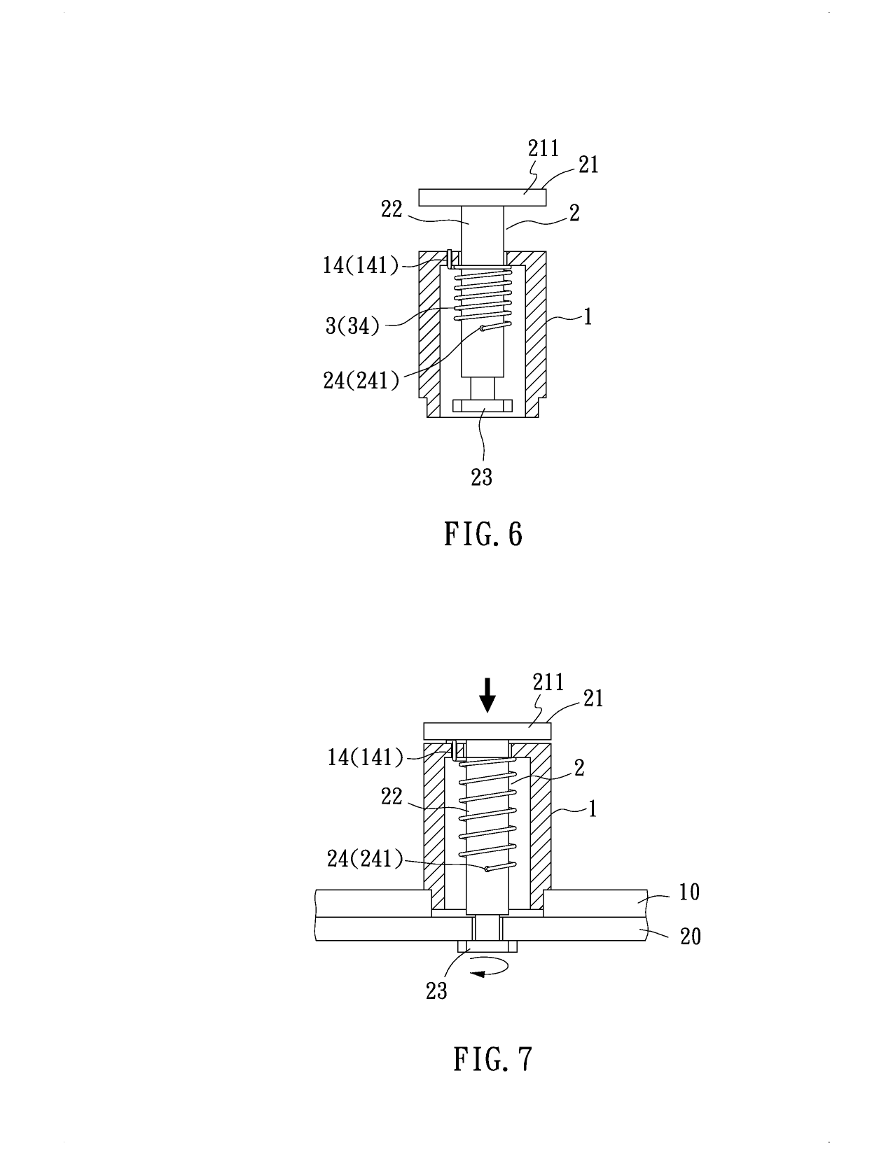

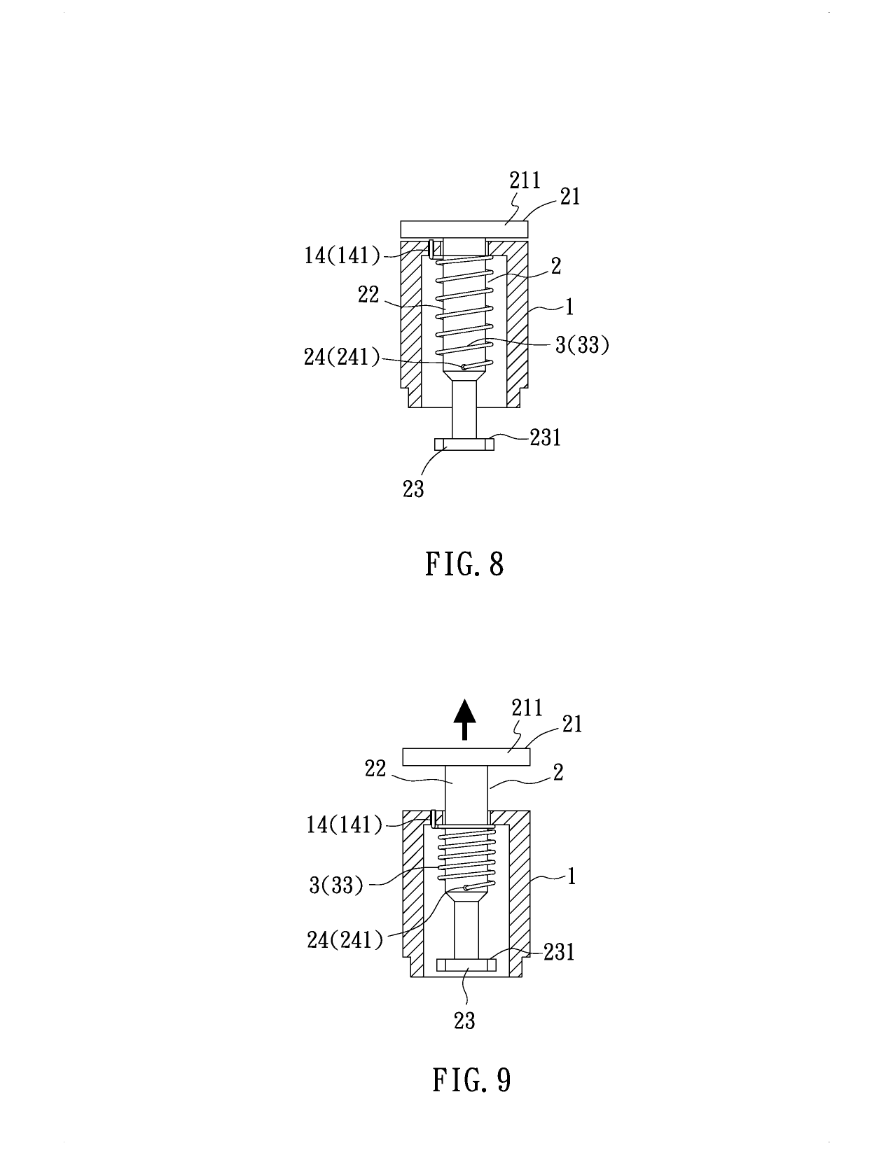

The main function of the torsional elastic element 3 is to drive the rotatable retainer 2 to rotate while moving axially, so that the first and the second plate 10, 20 can be quickly fastened to or quickly released from each other. In FIGS. 1 to 3, the illustrated first preferred embodiment of the torsional quick-connect fastening device of the present invention includes a torsional elastic element 3 configured as a coiled wire torsion-compression spring 33. However, in a first variant of the first preferred embodiment of the present invention as shown in FIGS. 6 and 7, the torsional elastic element 3 is configured as a coiled wire torsion-extension spring 34. When a user presses and turns the rotatable retainer 2 for the retaining section 23 refracted in the housing 1 to pass through the locking hole 201 on the second plate 20, either the coiled wire torsion-compression spring 33 or the coiled wire torsion-extension spring 34 is able to automatically turn the retaining section 23 for the same to tightly press the second plate 20 against the first plate 10. Alternatively, according to a second variant of the first preferred embodiment as shown in FIGS. 8 and 9, the coiled wire torsion-compression spring 33 can be connected to the housing 1 and the rotatable retainer 2 in a different manner, so that the retaining section 23 is normally pushed by the torsion-compression spring 33 to project from the second open end of the housing 1. In this case, the rotatable retainer 2 can be directly rotated for the retaining section 23 to pass through the locking hole 201 and then released. At this point, the elastic restoring force of the torsional elastic element 3 will automatically turn the retaining section to a position retained to behind the locking hole 201 on the second plate 20. On the other hand, the user may turn and pull the rotatable retainer 2 for the retaining section 23 to release from the second plate 20 and retract into the housing 1, as shown in FIG. 9.

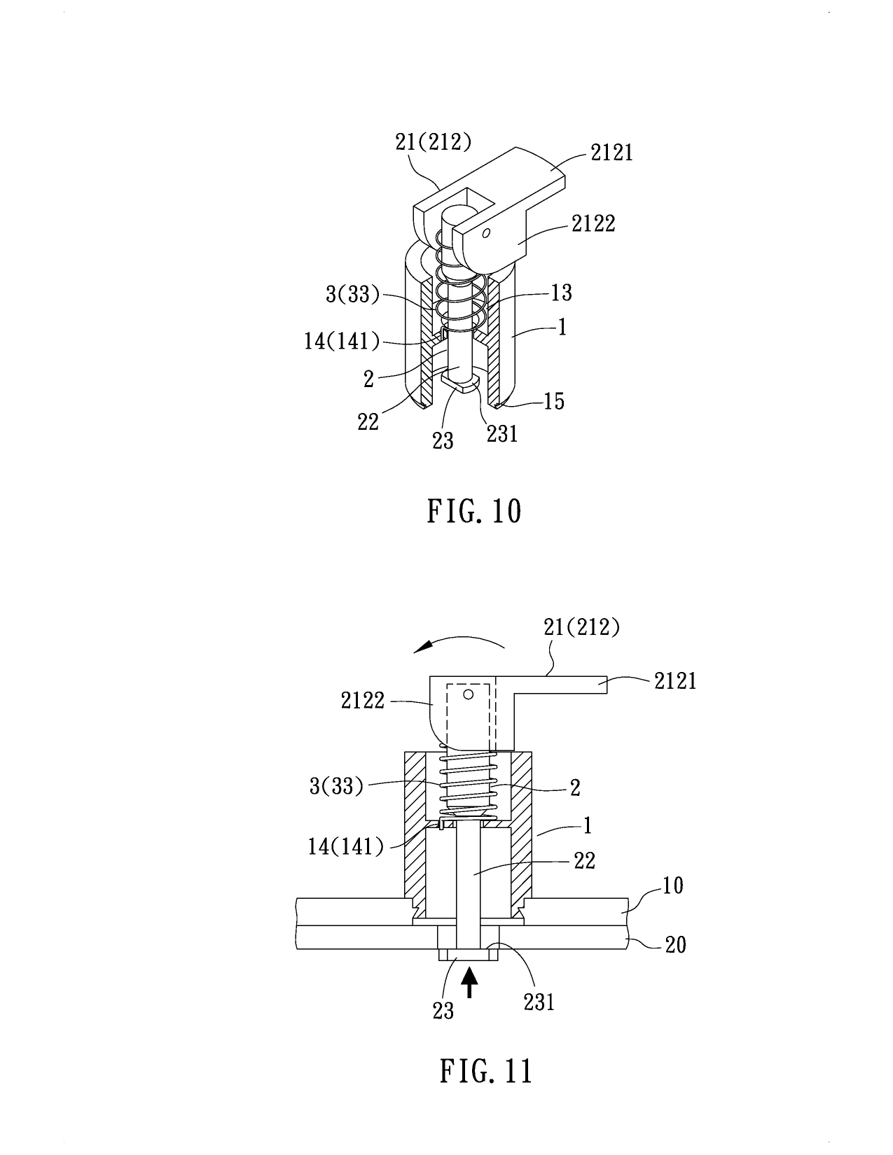

In the first preferred embodiment illustrated in FIGS. 1 to 3, and the first and the second variant thereof illustrated in FIGS. 6 and 7 as well as in FIGS. 8 and 9, respectively, the force-application portion 21 of the rotatable retainer 2 is configured as a hand-operating plate 211 integrally formed with or additionally assembled to the outer end of the interconnecting rod 22 opposite to the retaining section 23, such that the interconnecting rod 22 moves and turns along with the force-application portion 21, i.e. the hand-operating plate 211. Alternatively, in a third variant of the first preferred embodiment as shown in FIG. 10, the force-application portion 21 is configured as an operating lever 212 pivotally turnably connected to the outer end of the interconnecting rod 22 opposite to the retaining section 23. The operating lever 212 includes a hand lever 2121 and an acting section 2122 extended from the hand lever 2121. The hand lever 2121 may be in the form of a plate or a rod; and the acting section 2122 may be in the form of an eccentric wheel. The operating lever 212 is pivotally turnably connected at the acting section 2122 to the outer end of the interconnecting rod 22. When the user vertically turns the operating lever 212 in a predetermined direction as shown in FIG. 11, the interconnecting rod 22 of the rotatable retainer 2 is brought to move axially. Meanwhile, the user can also horizontally turn the operating lever 212 in a predetermined direction for the interconnecting rod 22 and the retaining section 23 to rotate synchronously, so as to quickly fasten or release the first plate 10 to or from the second plate 20 in an effortless manner, just as in other embodiments of the present invention.

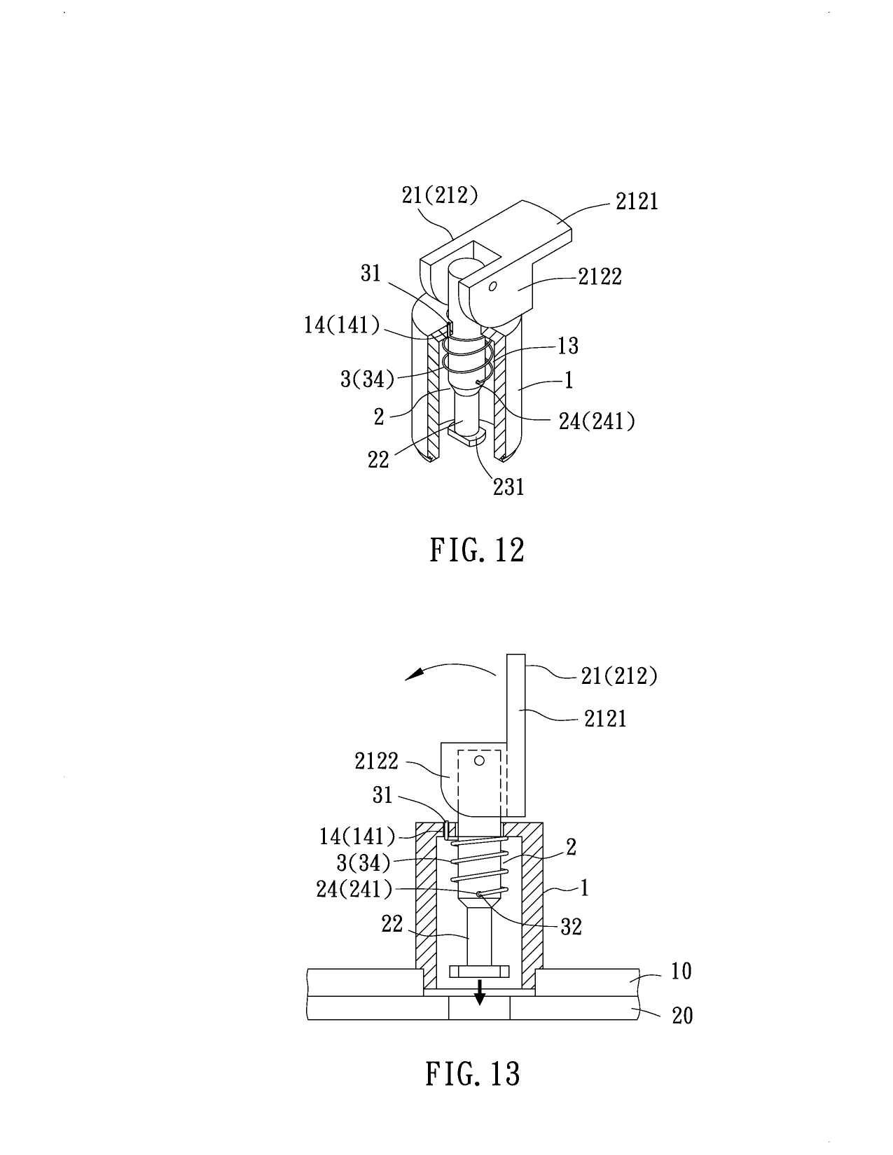

In the third variant of the first preferred embodiment as shown in FIGS. 10 and 11, the torsional elastic element 3 is a torsion-compression spring 33. And, in a fourth variant of the first preferred embodiment as shown in FIGS. 12 and 13, an operating lever 212 and a coiled wire torsion-extension spring 34 are employed. In either case, the vertical and the horizontal turning of the operating lever 2121 in predetermined directions can bring the retaining section 23 to retract into or to project from the second open end 12 of the housing 1, as shown in FIGS. 11 and 13, respectively, so as to release or fasten the second plate 20 from or to the first plate 10.

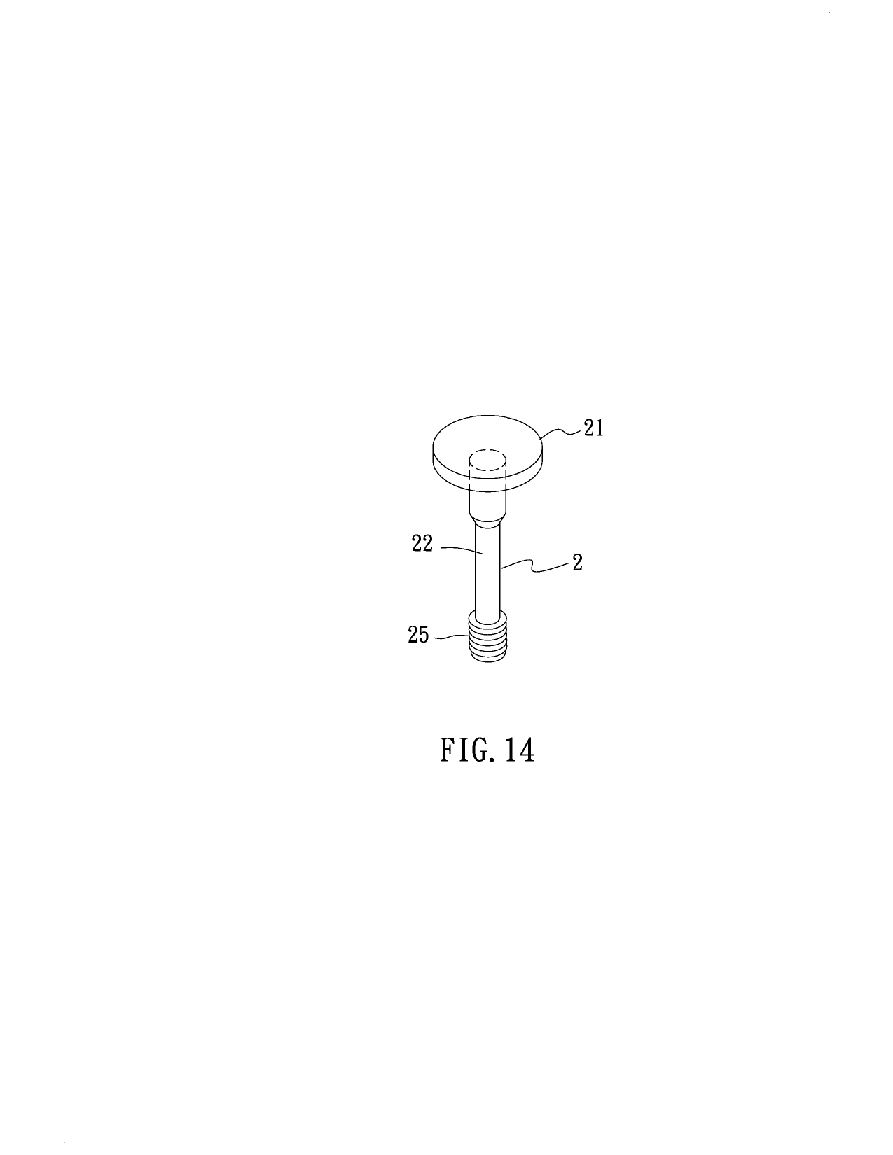

According to the first preferred embodiment illustrated in FIGS. 1 and 5, the retaining section 23 of the rotatable retainer 2 is in the form of an oblong or a rectangular or other non-circular block, and has two laterally symmetrical pressing surfaces 231 facing toward the force-application portion 21; and the locking hole 201 on the second plate 20 is an oblong or a rectangular or a non-circular hole corresponding to the retaining section 23. Thus, simply by rotating the rotatable retainer 2, the retaining section 23 can be brought to a position for fastening or releasing the second plate 20 to or from the first plate 10. However, according to another variant of the first preferred embodiment, the retaining section 23 can be otherwise configured as an externally threaded cylinder 25 as shown in FIG. 14, and the first and the second plate 10, 20 can also be quickly fastened to or released from each other by screwing or loosening the externally threaded cylinder 25 into or from the second plate 20.

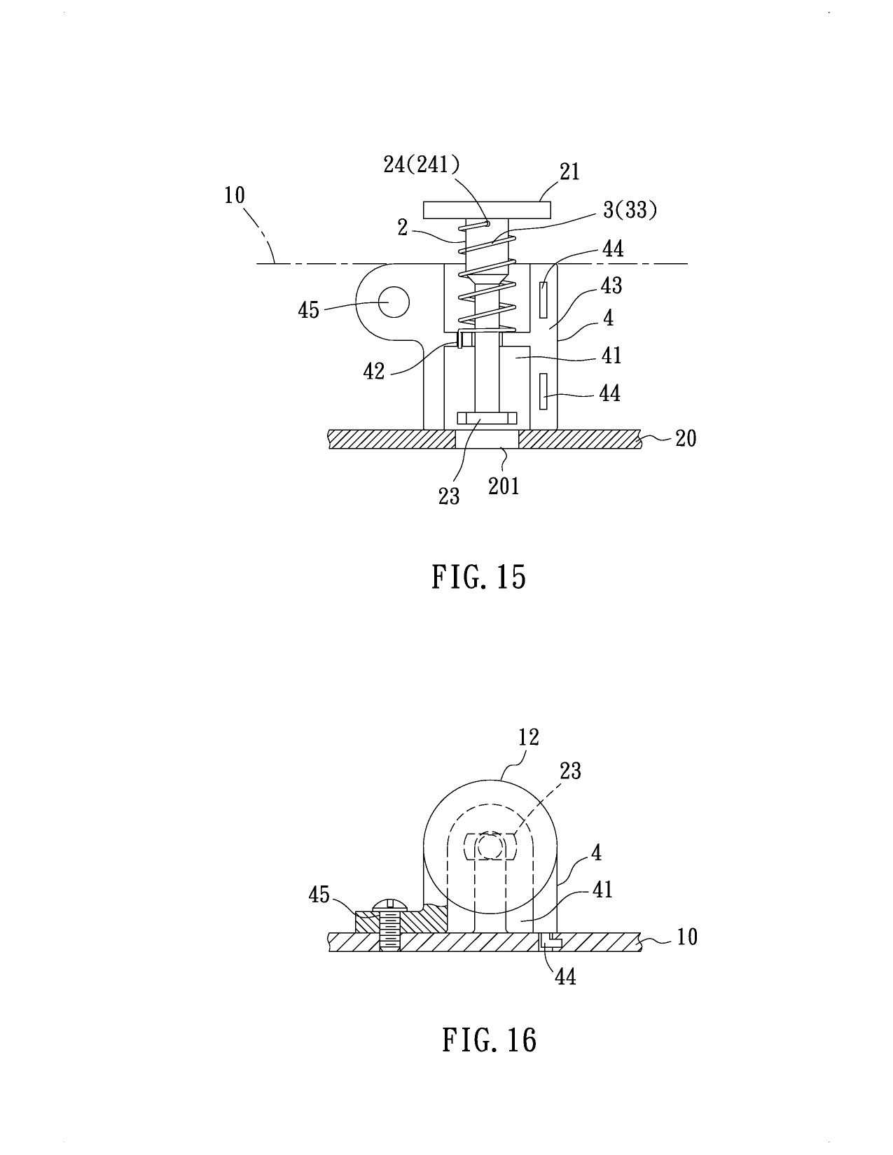

Please refer to FIGS. 15 and 16, in which a torsional quick-connect fastening device according to a second preferred embodiment of the present invention is shown. As shown, the torsional quick-connect fastening device in the second preferred embodiment is generally structurally similar to the first preferred embodiment and the variants thereof, except for a substantially U-shaped housing 4. The U-shaped housing 4 has an open side, an inner receiving space 41 communicating with the open side and two opposite open ends of the housing 4, a first holding structure 42 formed thereon at a predetermined position, and a locking section 45 laterally outward extended from the open side for locking to a mounting side of the first plate 10 in a predetermined manner. In the second preferred embodiment, the interconnecting rod 22 of the rotatable retainer 2 is also movably received in the receiving space 41 of the housing 4, the force-application portion 21 is located outside one open end of the housing 1, and the retaining section 23 is located at the other open end of the housing 4 and can be outward extended and turned for pressing the second plate 20 against the first plate 10. The open side of the U-shaped housing 4 forms an assembling side 43, which and the locking section 45 are attached to the mounting side of the first plate 10. The assembling side 43 of the housing 4 is further provided with a plurality of locating projections 44 for inserting into the mounting side of the first plate 10. With the torsional quick-connect fastening device according to the second preferred embodiment of the present invention, the first plate 10 and the second plate 20 can be perpendicularly connected to each other.

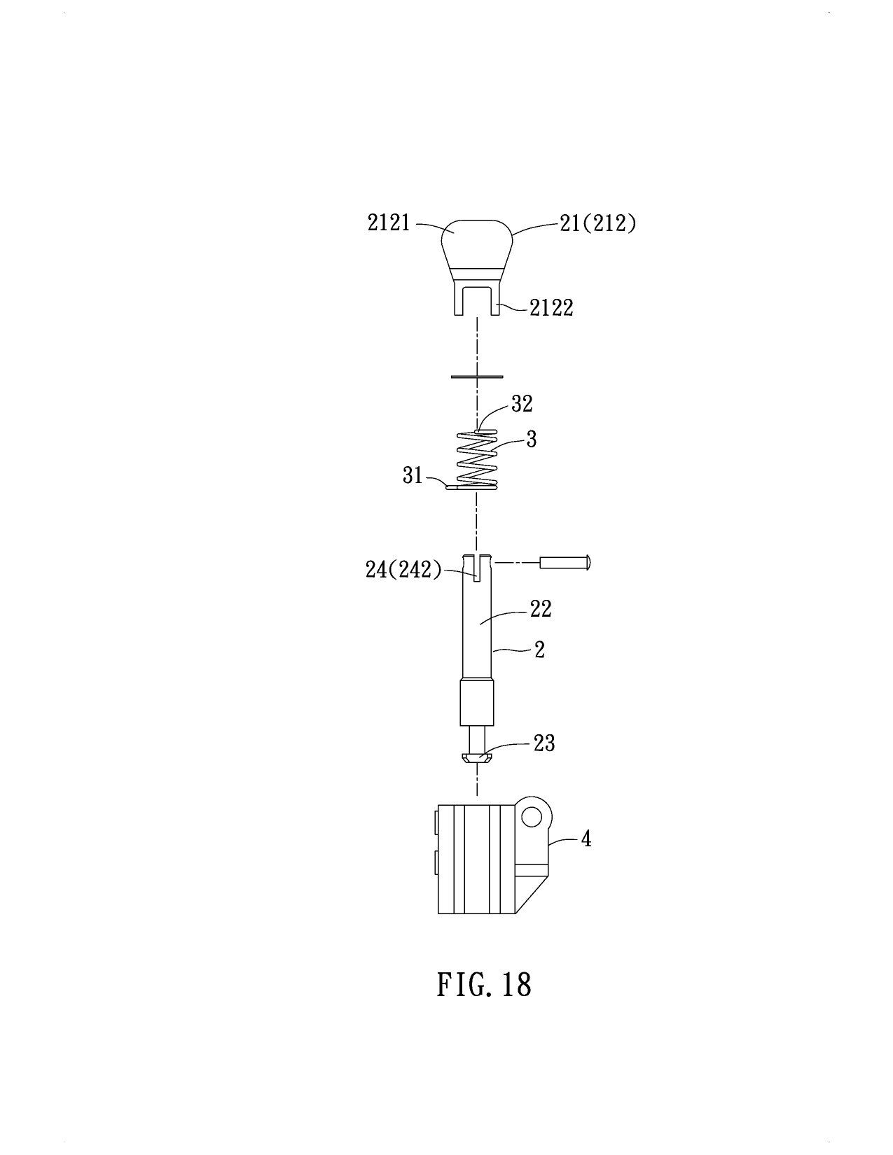

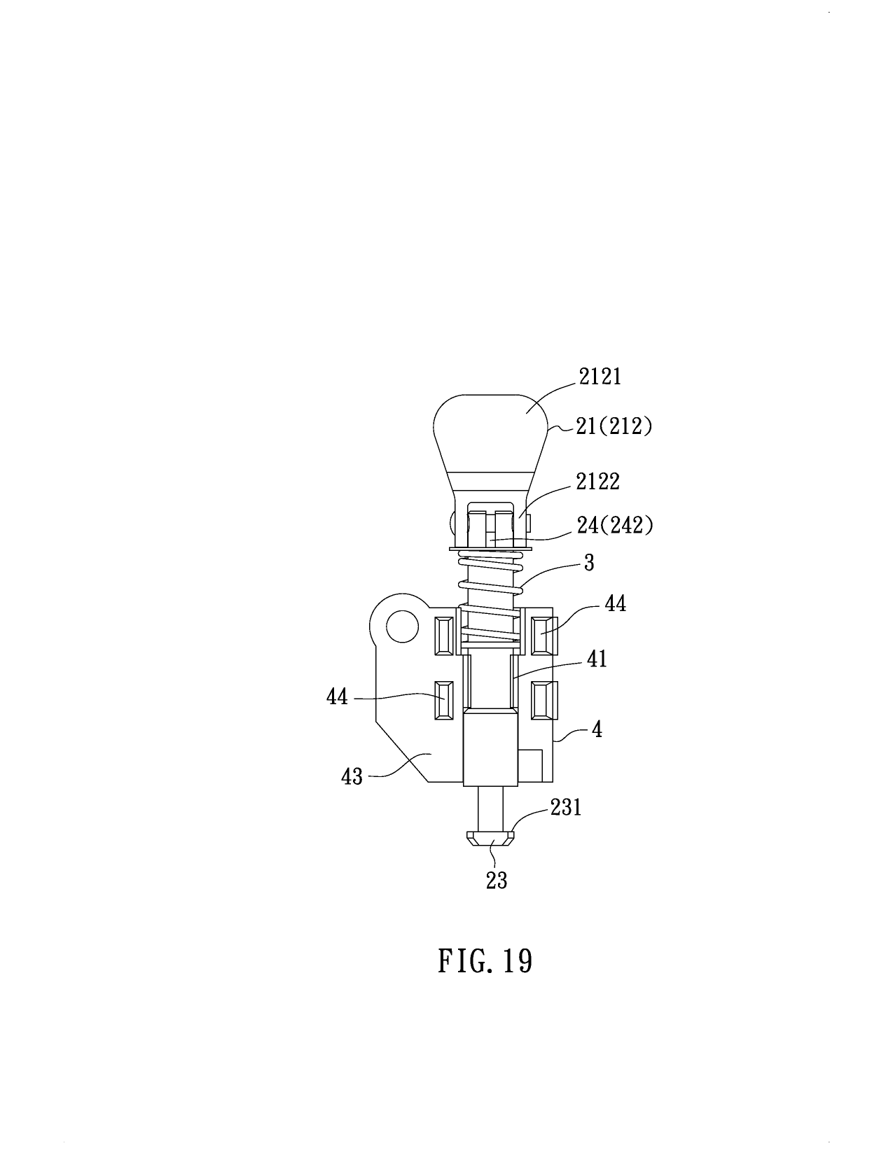

FIGS. 17 to 19 illustrate a variant of the second preferred embodiment. In this variant, the force-application portion 21 is configured as an operating lever 212, and the second holding structure 24 is an axially extended second holding slot 242 formed at the outer end of the interconnecting rod 22. The variant with the above structure can achieve the same function as the first and the second preferred embodiment and other variants thereof.

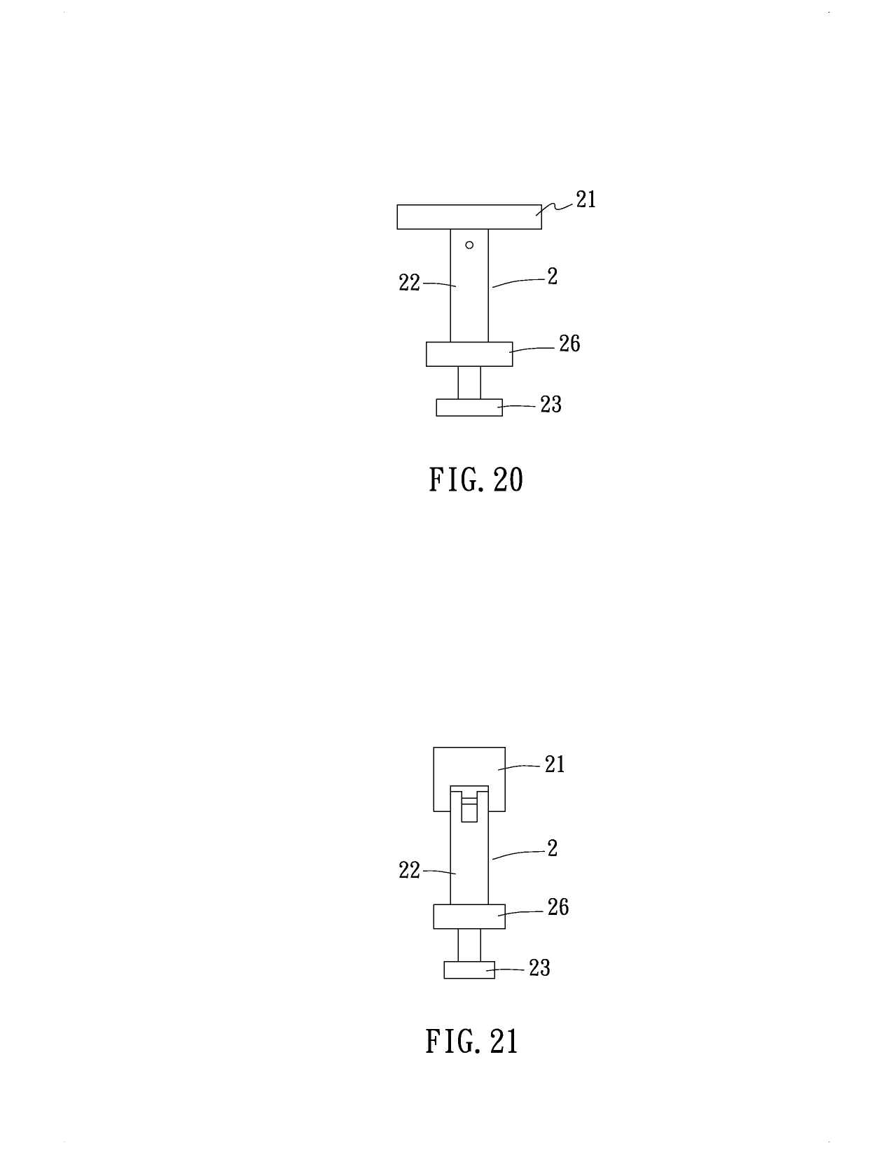

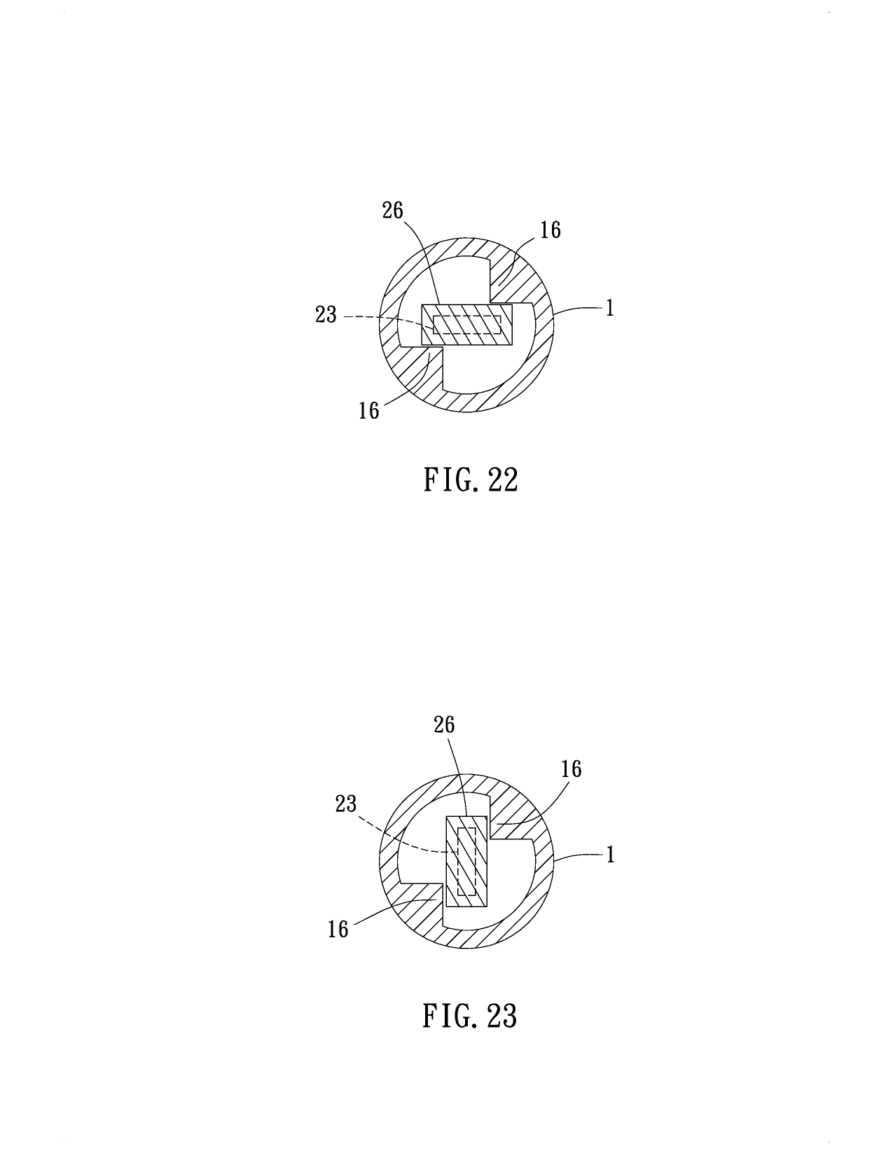

Please refer to FIGS. 20 and 21. The rotatable retainer 2 for the torsional quick-connect fastening device of the present invention can be further provided on the interconnecting rod 22 with a first stopper 26. And, as shown in FIGS. 22 and 23, the housing 1 for the torsional quick-connect fastening device of the present invention can be further internally provided with a second stopper 16 for correspondingly interfering with the first stopper 26, so as to define a maximum range within which the rotatable retainer 2 can be rotated relative to the housing 1.

With the above arrangements, the torsional quick-connect fastening device of the present invention is novel, improved and industrially practical for use. The present invention is novel and improved because, with the housing attached to the first plate and the torsional elastic element fixed between the housing and the rotatable retainer, the retaining section can be automatically turned to a position for quickly fastening the second plate to the first plate. The present invention is industrially practical for use because products derived from the present invention would no doubt satisfy the market demands.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A torsional quick-connect fastening device for quickly fastening a first plate to a second plate simply through a turning and pressing movement, comprising a housing, a rotatable retainer, and a torsional elastic member;
the housing being a hollow tubular member attached to the first plate, and having a first open end, an opposite second open end, an internal receiving space communicating with the first and the second open end, and a first holding structure provided on the housing at a predetermined position thereof;
the rotatable retainer being a long rod having a force-application portion, an interconnecting rod connected at an outer end to the force-application portion, a retaining section connected to an inner end of the interconnecting rod opposite to the force-application portion, and a second holding structure provided on the rotatable retainer at a predetermined position thereof; the interconnecting rod being movably received in the receiving space of the housing with the force-application portion located outside the first open end of the housing, and the retaining section being located at the second open end of the housing and being outward extendable and turnable to a position retained to behind the second plate; and
the torsional elastic element being a coiled wire torsion spring, and having a first and an opposite second fixing end connected to the first and the second holding structure on the housing and the rotatable retainer, respectively, so as to bring the rotatable retainer to rotate.

2. The torsional quick-connect fastening device as claimed in claim 1, wherein the first holding structure can be any one of a first holding hole or a first holding slot provided on the housing, and the first fixing end of the torsional elastic element being fixedly inserted into the first holding hole or slot.

3. The torsional quick-connect fastening device as claimed in claim 1, wherein the second holding structure can be any one of a second holding hole or a second holding slot provided on the rotatable retainer, and the second fixing end of the torsional elastic element being fixedly inserted into the second holding hole or slot.

4. The torsional quick-connect fastening device as claimed in claim 2, wherein the torsional elastic element is a coiled wire torsion-compression spring.

5. The torsional quick-connect fastening device as claimed in claim 3, wherein the torsional elastic element is a coiled wire torsion-compression spring.

6. The torsional quick-connect fastening device as claimed in claim 2, wherein the torsional elastic element is a coiled wire torsion-extension spring.

7. The torsional quick-connect fastening device as claimed in claim 3, wherein the torsional elastic element is a coiled wire torsion-extension spring.

8. The torsional quick-connect fastening device as claimed in claim 1, wherein the force-application portion of the rotatable retainer is a hand-operating plate, which can be integrally formed with or additionally assembled to the outer end of the interconnecting rod.

9. The torsional quick-connect fastening device as claimed in claim 1, wherein the force-application portion of the rotatable retainer is an operating lever pivotally turnably connected to the outer end of the interconnecting rod; the operating lever including a hand lever and an acting section extended from the hand lever, and the operating lever being pivotally turnably connected at the acting section to the outer end of the interconnecting rod; whereby when a force is applied to the operating lever at the hand lever, the rotatable retainer is brought to move.

10. The torsional quick-connect fastening device as claimed in claim 1, wherein the retaining section of the rotatable retainer is an oblong or a rectangular block and has two laterally symmetrical pressing surfaces facing toward the force-application portion for abutting on and pressing the second plate against the first plate when the retaining section is retained to behind the second plate.

11. The torsional quick-connect fastening device as claimed in claim 1, wherein the retaining section of the rotatable retainer has at least one pressing surface facing toward the force-application portion for abutting on and pressing the second plate against the first plate when the retaining section is retained to behind the second plate.

12. The torsional quick-connect fastening device as claimed in claim 1, wherein the torsional elastic element is capable of bringing the rotatable retainer to move axially while rotating.

13. The torsional quick-connect fastening device as claimed in claim 1, wherein the retaining section of the rotatable retainer is an externally threaded cylinder.

14. The torsional quick-connect fastening device as claimed in claim 1, wherein the housing is cylindrical or polygonal in cross-sectional shape.

15. The torsional quick-connect fastening device as claimed in claim 1, wherein the housing has a U-shaped cross section with the receiving space formed therein; and the U-shaped housing having an open side forming an assembling side for attaching to a mounting side of the first plate.

16. The torsional quick-connect fastening device as claimed in claim 15, wherein the assembling side of the U-shaped housing is provided with a plurality of locating projections for inserting into the mounting side of the first plate and a laterally outward extended locking section for locking to the mounting side of the first plate in a predetermined manner.

17. The torsional quick-connect fastening device as claimed in claim 1, wherein the rotatable retainer is further externally provided with a first stopper, and the housing is further internally provided with a second stopper for correspondingly interfering with the first stopper, such that the second stopper defines a maximum range within which the first stopper and according, the rotatable retainer can be rotated relative to the housing.
